(19) United States
(12) Patent Application Publication
(10) Pub. No.: US 2020/0147764 A1
(43) Pub. Date: May 14, 2020

(54) WRENCH WTH TWO CLAMPING PARTS

(71) Applicant: Jia-Guann Liau, Taichung (TW)

(72) Inventor: Jia-Guann Liau, Taichung (TW)

(21) Appl. No.: 16/186,599

(22) Filed: Nov. 12, 2018

(51) Int. Cl. B25B 13/30

(52) U.S. Cl. CPC B25B 13/30

(57) ABSTRACT

A wrench includes a first part and a second part which is overlapped on the first part and is pivotable relative to the first part. The first part has a first clamping space and the second part has a second clamping space which is located corresponding to the first clamping space. The first clamping space is defined by two first jaws. The second clamping space is defined by two second jaws. When an object is clamped by the first and second parts, the second part is able to be pivoted an angle relative to the first part to allow the object to be firmly clamped by the first and second parts.

### BACKGROUND OF THE INVENTION

### 1. Fields of the Invention

The present invention relates to a wrench, and more particularly, to a wrench with two clamping parts which are pivotable relative to each other so as to firmly clamp an object.

### 2. Descriptions of Related Art

The conventional wrench such as disclosed in U.S. Pat. No. 8,459,153, discloses an inward opening that has a multi-point configuration for partially-surrounding engagement in a torque-transmitting manner on a polygonal profile of a nut or a bolt head. A radial jaw opening is associated with the inward opening and at least two corners of the multi-point configuration each have a stop for a portion of an end face of the polygonal profile. In order to extend the range of use of the wrench, the jaw opening has oppositely-disposed jaw cheeks as the opening of an open-end wrench for torque-transmitting engagement on the polygonal profile, the jaw cheeks extending over the corners of the multi-point configuration on only one wide face of the wrench.

However, when the jaw portions or the multiple-point configurations clamp and rotate the bolt head, there is a gap formed between the jaw portions or the multiple-point configurations clamp and rotate the bolt head.

The steel plate is fixed to the head so that the wrench can only be operated in two ways to clamp the bolt head.

When the bolt head is rounded, the jaw portions or the multiple-point configurations are not able to well clamp and rotate the bolt head.

The present invention is intended to provide a wrench that includes two clamping parts so as to firmly clamp the object and the drawbacks mentioned above are removed.

### SUMMARY OF THE INVENTION

The present invention relates to a wrench and comprises a first part and a second part which is overlapped on the first part and is pivotable relative to the first part. The first part has a first clamping space and the second part has a second clamping space which is located corresponding to the first clamping space. The first clamping space is defined by two first jaws. The second clamping space is defined by two second jaws. When an object is clamped by the first and second parts, the second part is able to be pivoted an angle relative to the first part to eliminate the gap between the wrench and the object, and the object is firmly clamped by the first and second parts.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the wrench of the present invention;

FIG. 2 is a top view of the first part of the wrench of the present invention;

FIG. 3 is a top view of the second part of the wrench of the present invention;

FIG. 4 is a perspective view to show the wrench of the present invention;

FIG. 5 is a top view to show the first operative status of the wrench of the present invention;

FIG. 6 is a top view to show the second operative status of the wrench of the present invention;

FIG. 7 is a top view to show the third operative status of the wrench of the present invention;

FIG. 8 is a top view to show the fourth operative status of the wrench of the present invention;

FIG. 9 is a top view to show the fifth operative status of the wrench of the present invention;

FIG. 10 is a perspective view to show the second embodiment of the wrench of the present invention;

FIG. 11 is an exploded view of the third embodiment of the wrench of the present invention;

FIG. 12 is a perspective view to show the third embodiment of the wrench of the present invention;

FIG. 13 is an exploded view of the fourth embodiment of the wrench of the present invention, and

FIG. 14 is a perspective view to show the fourth embodiment of the wrench of the present invention.

### DETAILED DESCRIPTION OF THE PREFERRED EMBODIMENT

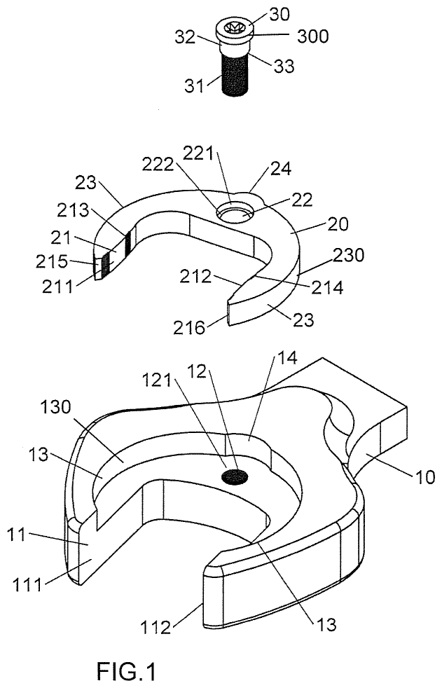

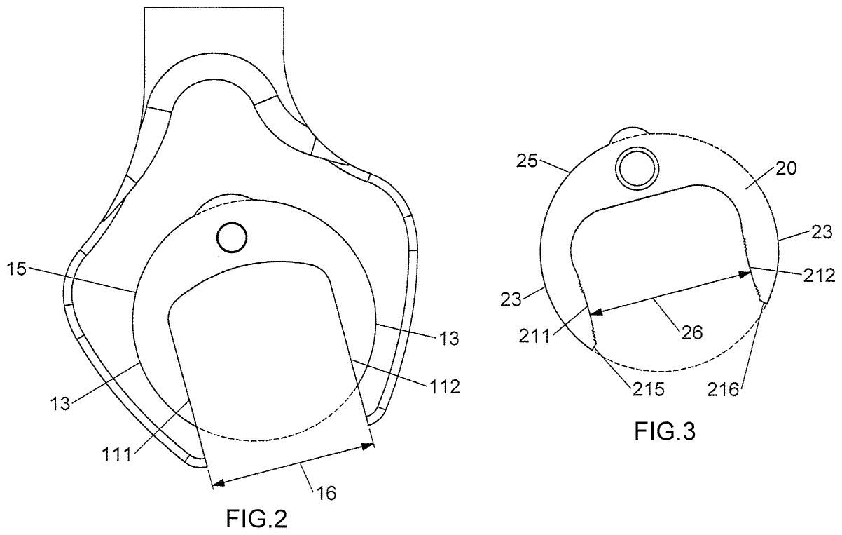

Referring to FIGS. 1 to 3, the wrench of the present invention comprises a first part 10, a second part 20 and a locking member 30. The first part 10 has a first clamping space 11 defined in one end thereof, and the first clamping space 11 is defined by two first jaws 111, 112. Each of the first jaws 111, 112 has a flat face and the two flat faces face each other. A threaded hole 12 is defined in the first part 10 and includes a first contact portion 121 formed at an end of the threaded hole 12. A curved recessed area 130 is formed in the top of the first clamping space 11 and includes two inner walls 13 and a recess 14 which is located between the two inner walls 13. The two inner walls 13 are located corresponding to the two first jaws 111, 112. The recess 14 is a curved recess. The two inner walls 13 are located along a first circle 15. A first distance 16 is formed between the two first jaws 111, 112.

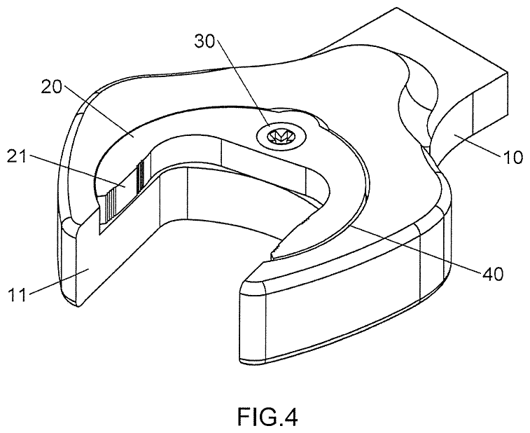

The second part 20 is overlapped to the top of the first part 10 and pivotably connected to the first part 10. The second part 20 is located in the curved recessed area 130. The second part 20 has a second clamping space 21 which is located corresponding to the first clamping space 11. The second clamping space 21 is defined by two second jaws 211, 212. The two second jaws 211, 212 are located corresponding to the two first jaws 111, 112. Each of the second jaws 211, 212 is a protruded face and the two protruded faces face each other. One of the second jaws 211 includes two first toothed faces 213 which are spaced from each other. The other one of the second jaws 211 includes two second toothed faces 214 which are spaced from each other. The two first toothed faces 213 are located corresponding to the two second toothed faces 214. One of the second jaws 211 includes a first inclined face 215 formed at the distal end thereof, and the other one of the second jaws 211 includes a second inclined faces 216 formed at the distal end thereof. The second part 20 has a through hole 22 which includes an enlarged receiving room 221 formed in the top end thereof, and a flange 222 extends from the lower end thereof. The diameter of the enlarged receiving room 221 is larger than that of the through hole 22. The second part 20 has a curved outer periphery 230 and includes a protrusion 24 which is located between two outer walls 23 of the curved outer periphery 230. The two outer walls 23 are located along a second circle 25. The second part 20 is pviotably located within the curved recessed area 130. The two inner walls 13 and the protrusion 24 restrict a maximum angle that the second part 20 is pivoted relative to the first part 10. The minimum distance between the two second jaws 211, 212 is defined as a second distance 26. The diameter of the second circle 25 is smaller than that of the first circle 15. As shown in FIG. 4, a first gap 40 is formed between the inner walls 13 and the outer walls 23.

The first distance 16 is a maximum allowable value relative to a DIN standard size between the two first jaws 112, and the second distance 26 is a minimum allowable value relative to the DIN standard size between the two second jaws 212. For example, assume that the standard size is 19 mm, according to DIN standard size, the first distance 16 is 19.36 mm and the second distance 26 is 19.06 mm. Alternatively, the first distance 16 is a minimum allowable value relative to the DIN standard size between the two first jaws 112, and the second distance 26 is a maximum allowable value relative to the DIN standard size between the two second jaws 212. Alternatively, the first distance 16 is close to the second distance 26, or the first distance 16 is equal to the second distance 26.

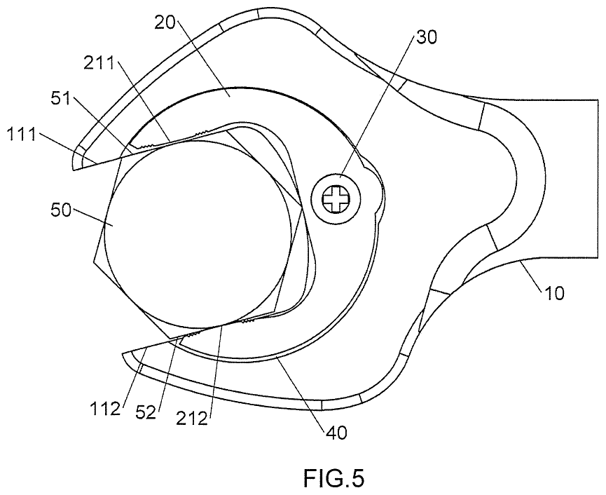

The locking member 30 extends through the through hole 22 and is connected to the threaded hole 12 to pivotably connect the first part 10 to the second part 20. The locking member 30 includes a head 300, a threaded shank 31 and an intermediate portion 32 that is formed between the head 300 and the threaded shank 31. The diameter of the intermediate portion 32 is larger than that of the threaded shank 31 so as to form a shoulder 33 between the intermediate portion 32 and the threaded shank 31. The intermediate portion 32 of the locking member 30 is located in the through hole 22 and the threaded shank 31 is threadedly connected to the threaded hole 12. The shoulder 33 contacts the contact portion 121 of the threaded hole 12. The head 300 is located in the enlarged receiving room 221. When an object 50 is clamped by the first and second parts 10, 20 as shown in FIG. 5. When the wrench and the object 50 are rotated clockwise, there are two sides 51, 52 of the object 50 are respectively located within the first clamping space 11 and the second clamping space 21. The first side 51 contacts the first jaw 111, and there is a gap formed between the second side 52 and the other first jaw 112. The second part 20 is pivoted an angle about the locking member 30 relative to the first part 10, one of the outer walls 23 contacts one of the inner walls 13, and the other one of the outer walls 23 is moved away from the other one of the inner walls 13. The second jaw 212 of the second part 20 contacts the second side 52 so that the first and second sides 51, 52 of the object 50 are respectively in contact with the first and second jaws 111, 112 without the gap mentioned above. Therefore, the object 50 can be firmly clamped and rotated.

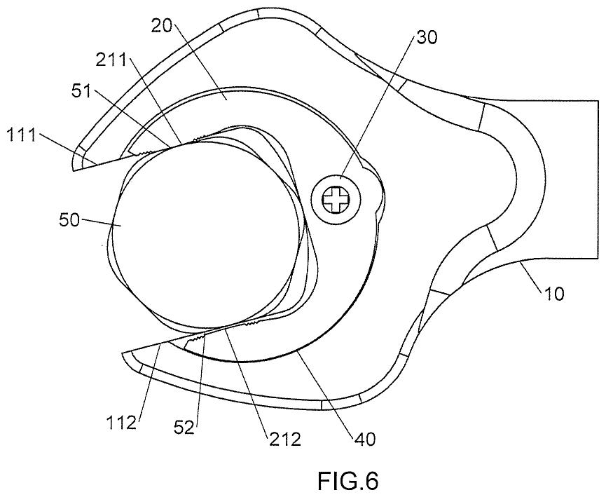

As shown in FIG. 6, when the object 5 is rounded, and the wrench and the object are rotated counter clockwise, the second side 52 of the object 50 contacts the first jaw 112, and a gap is formed between the first side 51 of the object 50 and the first jaw 111. When the second part 20 is pivoted an angle, the second jaw 211 contacts the first side 51 so that the gap mentioned above is disappeared, and the object 50 can be firmly clamped and rotated.

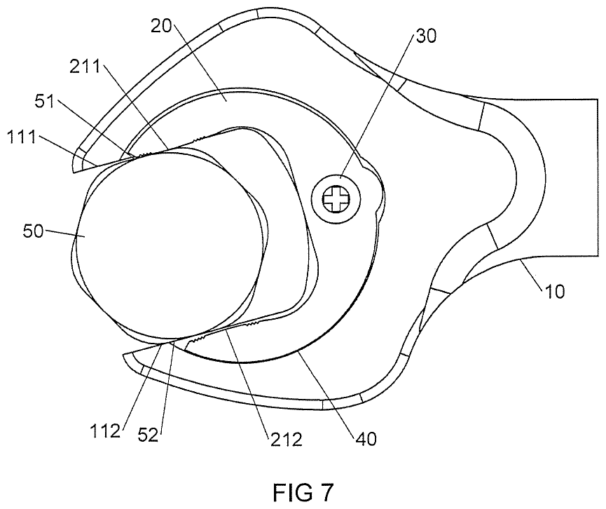

As shown in FIG. 7, when the object 5 is rounded, and the wrench and the object are rotated counter clockwise, the object 50 moves away from the wrench slightly and is still located within the first and second clamping spaces 11, 21. There is a gap formed between the first side 51 of the object 50 and the first jaw 111, and the second side 52 of the object 50 does not contact the first jaw 112. The first toothed faces 213 contact the first side 51 so that the object 50 can be firmly clamped and rotated.

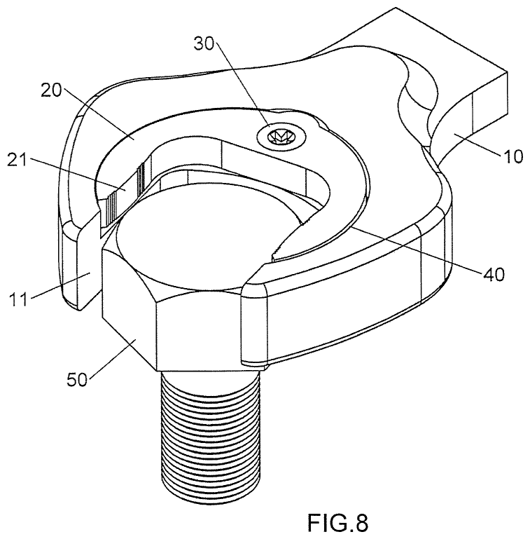

FIG. 8 shows that the object 50 is located only in the first clamping space 11.

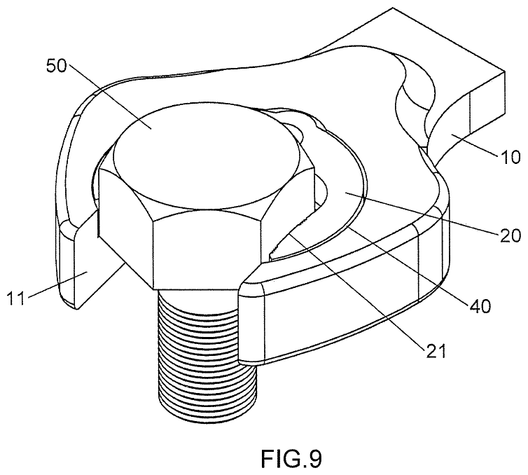

FIG. 9 shows that the object 50 is located only in the second clamping space 21, and the top head of the object 50 protrudes beyond the first part 10. The object 50 can also be rotated by the wrench.

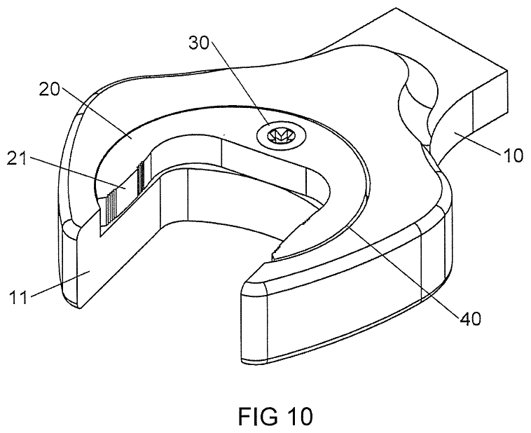

FIG. 10 shows that the first part 10 does not have the recess 14, and the second part 20 does not have the protrusion 24.

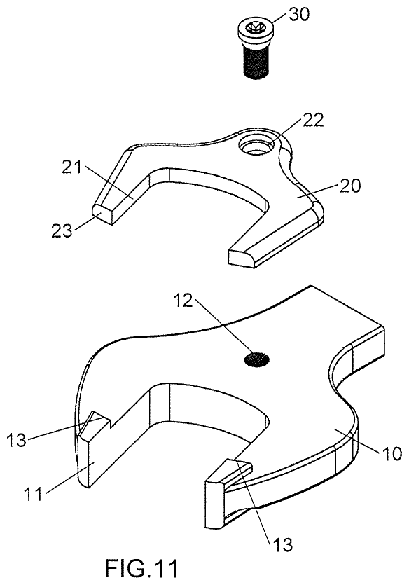

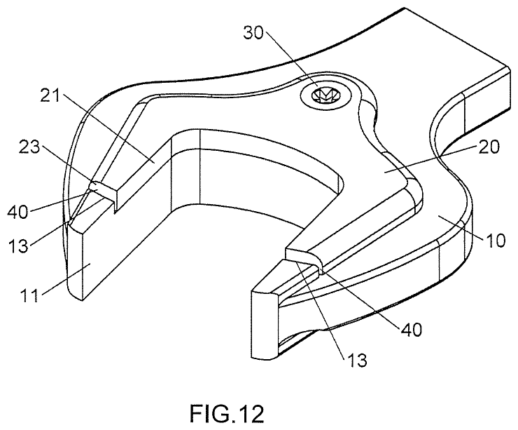

FIGS. 11 and 12 show that each of the two inner walls 13 is a flat face and located at the distal end of the first part 10 corresponding thereto. The first part 10 does not have the recess 14. Each of the two outer walls 23 is a flat face and located at the distal end of the second part 20 corresponding thereto. The second part 20 does not have the first and second toothed faces 213, 214, the first inclined face 215, the second inclined face 216 and the protrusion 24. When one of the outer walls 23 contacts one of the inner walls 13, the other one of the outer walls 23 is moved away from the other one of the inner walls 13.

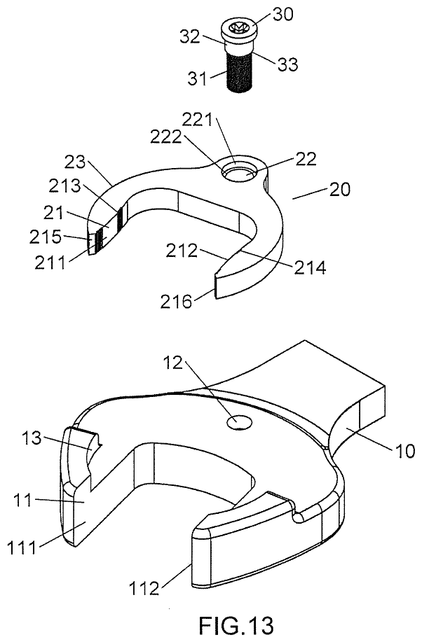

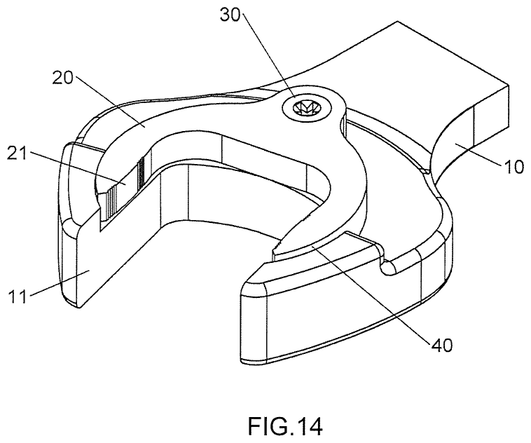

FIGS. 13 and 14 show that first part 10 does not have the recess 14 and the second part 20 does not have the protrusion 24.

The advantages are that the second part 20 is overlapped to the top of the first part 10 and pivotably connected to the first part 10. The object 50 is clamped by both of the first and second parts 10, 20 so as to be firmly rotated.

When the second part 20 is pivoted relative to the first part 10, the outer walls 23 contact the inner walls 13, and the inner walls 13 and the recess 14 restrict the maximum angle that the second part 20 is pivoted relative to the first part 10.

The object 50 are protected from being worn out by the first and second parts 10, 20.

As shown in FIGS. 5 to 9, there are at least five operational statuses can be used of the wrench.

The object 50 is clamped by the first and second clamping spaces 11, 21, there is a gap formed between the second side 52 and the first jaw 112. The second part 20 is pivoted an angle about the locking member 30 relative to the first part 10, the first and second sides 51, 52 respectively contact the first and second jaws 111, 212, so that the object 50 can be firmly clamped and rotated.

The shoulder 33 contacts the contact portion 121. The intermediate portion 32 is thicker than the second part 20, when the locking member 30 extends through the through hole 22 and is connected to the threaded hole 12, the second part 20 is pivotable.

While we have shown and described the embodiment in accordance with the present invention, it should be clear to those skilled in the art that further embodiments may be made without departing from the scope of the present invention.

What is claimed is:

1. A wrench comprising:
a first part having a first clamping space defined in one end thereof, the first clamping space defined by two first jaws, each of the first jaws having a flat face and the two flat faces facing each other, a threaded hole defined in the first part and having a first contact portion formed at an end of the threaded hole, a curved recessed area formed in a top of the first clamping space and including two inner walls which are located corresponding to the two first jaws, a first distance formed between the two first jaws;
a second part pivotably connected to the first part and located in the curved recessed area, the second part having a second clamping space which is located corresponding to the first clamping space, the second clamping space defined by two second jaws, the two second jaws located corresponding to the two first jaws, and each of the second jaws have a protruded face and the two protruded faces facing each other, the second part having a through hole which includes an enlarged receiving room formed in a top end thereof, and a flange extending from a lower end thereof, the second part having two outer walls, a minimum distance between the two second jaws being defined as a second distance, a first gap formed between the inner walls and the outer walls, and
a locking member extending through the through hole and connected to the threaded hole to pivotably connect the first part to the second part, the locking member including a head, a threaded shank and an intermediate portion that is formed between the head and the threaded shank, a diameter of the intermediate portion being larger than that of the threaded shank so as to form a shoulder between the intermediate portion and the threaded shank, the intermediate portion of the locking member located in the through hole and the threaded shank threadedly connected to the threaded hole, the shoulder contacting the contact portion of the threaded hole, the head is located in the enlarged receiving room, when the second part is pivoted an angle about the locking member relative to the first part, one of the outer walls contacts one of the inner walls, and the other one of the outer walls is moved away from the other one of the inner walls.

2. The wrench as claimed in claim 1, wherein the inner walls each are a curved face, the outer walls each are a curved face.

3. The wrench as claimed in claim 1, wherein the first part includes a recess which is located between the two inner walls, the second part includes a protrusion which is engaged with the recess, the second part is pivoted relative to the first part, the two inner walls and the protrusion restrict a maximum angle that the second part is pivoted relative to the first part.

4. The wrench as claimed in claim 1, wherein the two inner walls are located along a first circle, the two outer walls are located along a second circle, a diameter of the second circle is smaller than that of the first circle.

5. The wrench as claimed in claim 1, wherein one of the second jaws includes two first toothed faces which are spaced from each other, the other one of the second jaws includes two second toothed faces which are spaced from each other, the two first toothed faces are located corresponding to the two second toothed faces.

6. The wrench as claimed in claim 1, wherein one of the second jaws includes a first inclined face formed at a distal end thereof, the other one of the second jaws includes a second inclined faces formed at a distal end thereof

7. The wrench as claimed in claim 1, wherein the first distance is a maximum allowable value relative to a DIN standard size between the two first jaws, and the second distance is a minimum allowable value relative to the DIN standard size between the two second jaws, or the first distance is a minimum allowable value relative to the DIN standard size between the two first jaws, and the second distance is a maximum allowable value relative to the DIN standard size between the two second jaws, or the first distance is equal to the second distance.

8. The wrench as claimed in claim 1, wherein each of the two inner walls is a flat face and located at a distal end of the first part corresponding thereto, each of the two outer walls is a flat face and located at a distal end of the second part corresponding thereto, when one of the outer walls contacts one of the inner walls, the other one of the outer walls is moved away from the other one of the inner walls.
